(19) United States
(12) Patent Application Publication
(10) Pub. No.: US 2004/0266251 A1
(43) Pub. Date: Dec. 30, 2004

(54) Electrical connector with integrated strain relief attachment clip

(76) Inventors: Michael J. Muchlinski, Victoria, MN (US); William B. Green, Shakopee, MN (US); Curtis A. Trammell, Newcastle, OK (US); David S. Allsup, Oklahoma City, OK (US); John D. Stricklin, Oklahoma City, OK (US)

Correspondence Address: Seagate Technology LLC, 1280 Disc Drive, Shakopee, MN, 55379, US

(21) Appl. No.: 10/606,527

(22) Filed: Jun. 26, 2003

(51) Int. Cl. H01R 11/20

(52) U.S. Cl. 439/439

(57) ABSTRACT

Method and apparatus for providing strain relief for an electrical connector, such as an edge connector affixed to a printed circuit board (PCB). The connector includes a dielectric body which supports a number of electrical contacts each having a proximal end configured for electrical and mechanical engagement to a device, preferably via a soldering operation. One or more strain relief clips are inserted into associated recesses formed in the body of the connector. Each strain relief clip is configured for attachment to the device using a solder connection to relieve strain forces upon the electrical contacts upon installation of the connector onto the device. As desired, advanced ground contact functions can further be incorporated into the strain relief clips.

### FIELD OF THE INVENTION

The claimed invention relates generally to the field of electronics and more particularly, but not by way of limitation, to a method and apparatus for reducing strain in solder joint connections used to electrically and mechanically attach a connector to a device such as a printed circuit board (PCB).

### BACKGROUND

Electrical connectors are often used to facilitate the interconnection of various electronic devices. For example, a printed circuit board (PCB) can be provided with one or more connectors each having an array of connection contacts (e.g. rigid pins, leaf-spring compression members, etc.). Each contact typically includes one end that is mechanically and electrically connected to a conductive pad on the PCB using a solder connection.

The opposite end of each connection pin or contact is generally oriented in a direction away from the PCB so as to enable interconnection with another connector extending from another PCB or a cable. In this way, a number of individual electrical signal paths and/or electrical power connections can be concurrently established for the PCB via the pair of mating connectors.

Electrical connectors are often used in the field of disc drives, which are data storage devices used to store and retrieve digital data in a computer based environment. A commonly employed disc drive configuration includes a disc drive PCB which supports various communication and control electronic circuits for the drive. The disc drive PCB is affixed to a head/disc assembly (HDA) comprising a sealed housing with various mechanical components supported therein, such as discs, data transducing heads, etc.

The disc drive PCB often includes various connectors such as a primary interface connector and a power connector. The primary interface connector conforms to a selected industry communication protocol standard (SCSI, ATA, Fibre Channel, etc.), and typically mates with a ribbon cable to connect the disc drive to an interface board or a motherboard of a host computer device. The power connector accommodates the transfer of electrical power to the PCB at various voltage levels (+5V, −5V, +12V, etc.) via a power cable from a power supply of the host device.

It is desirable to avoid the application of excessive strain forces to a connector to reduce the likelihood of generating fractures in or otherwise damaging the connections between the connector pins or contacts and the pads. Particularly, with regard to disc drives, the continuing push for successive generations of drives having ever increasing data transfer rates makes it increasingly important to protect against damage to the solder interconnections in disc drive PCB connectors, to ensure intermittent connections and electrical noise are not generated.

Thus, while various approaches have been proposed in the art to provide strain relief for electrical connectors, there remains a continued need for improvements in the art, and it is to such improvements that the present invention is directed.

### SUMMARY OF THE INVENTION

As embodied herein and as claimed below, the present invention is generally directed to a method and an apparatus for providing strain relief for an electrical connector.

In accordance with preferred embodiments, an electrical connector is provided having a dielectric body which supports a number of electrical contacts. Each contact has a proximal end configured for electrical and mechanical engagement to a device (e.g., a printed circuit board, PCB) preferably by way of a soldering operation. Each contact preferably further includes a distal end configured for electrical and mechanical engagement with a second, mating connector at a distal end of a ribbon cable or other device.

A strain relief clip is retained within an associated recess in the body, the strain relief clip configured for attachment to the device using a solder connection to relieve strain forces upon the electrical contacts.

The strain relief clip preferably has a substantially u-shaped configuration and comprises a pair of opposing cantilevered arms that project from a retaining base. The arms are preferably configured to provide an interference fit with the device (PCB) and to be soldered to the device during a reflow solder operation.

The arms preferably are provided with an effective width that is greater than a width of each of the electrical contacts, providing a substantially stiffer and larger solder joint. In this way, mechanical strain loads applied to the connector after installation are largely transferred to the structural solder joints and the effective strength of the attachment of the connector is enhanced.

These and various other features and advantages which characterize the claimed invention will become apparent upon reading the following detailed description and upon reviewing the associated drawings.

### BRIEF DESCRIPTION OF THE DRAWINGS

FIG. 1 is a plan view of a disc drive data storage device constructed in accordance with preferred embodiments of the present invention.

FIG. 2 provides a plan view of a disc drive printed circuit board (PCB) affixed to the underside of the base deck of FIG. 1, the PCB incorporating an edge connector constructed in accordance with preferred embodiments of the present invention.

FIG. 3 is a side elevational view of the edge connector of FIG. 2.

FIG. 4 is a partially exploded view of the edge connector and PCB of FIG. 2 to illustrate the use of strain relief clips (solder clips) that are incorporated into the body of the connector to further affix the connector to the PCB.

FIG. 5 provides an elevational view of one of the clips of FIG. 4.

FIG. 6 provides a plan view of the clip of FIG. 5.

FIG. 7 is a front view of the connector to illustrate the manner in which the clip of FIGS. 5 and 6 is housed within the connector to engage the PCB.

FIG. 8 is a side, partial cross-sectional view of the arrangement of FIG. 7.

FIG. 9 is a side elevational view of an advance ground contact (AGC) contact of the connector.

FIG. 10 provides an end elevational view of the AGC contact of FIG. 9.

FIG. 11 provides an isometric view of the clip in accordance with an alternative embodiment in which the grounding functions of the AGC of FIG. 9 are incorporated into the clip.

FIG. 12 is a flow chart for a CONNECTOR STRAIN RELIEF routine, generally representative of steps carried out in accordance with preferred embodiments of the present invention to provide strain relief for the connector of FIG. 2.

### DETAILED DESCRIPTION

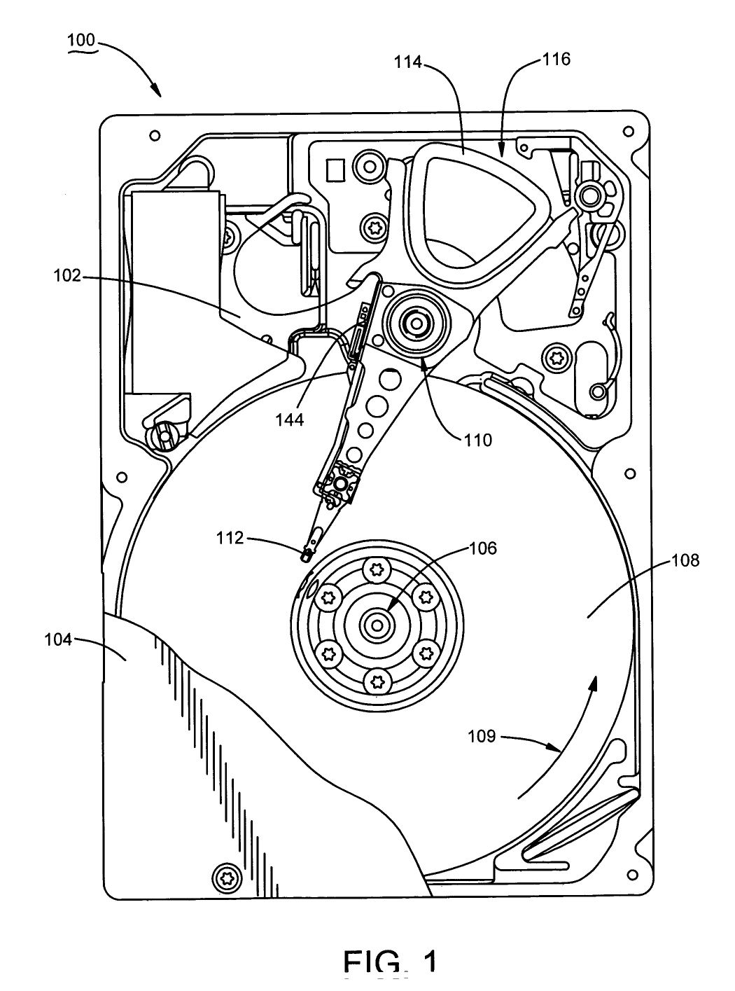

FIG. 1 provides a plan view of a disc drive data storage device 100. The disc drive 100 is configured to magnetically store digital data from a host computer (not shown).

The disc drive 100 includes a base deck 102 and a top cover 104 (shown in partial cutaway) which cooperate to form a sealed housing. A spindle motor 106 is supported within the housing to rotate a number of magnetic recording discs 108 at a constant, high speed in direction 109. A rotary actuator 110 controllably moves a corresponding number of data transducing heads 112 across recording surfaces of the discs 108 through application of current to a coil 114 of a voice coil motor (VCM) 116.

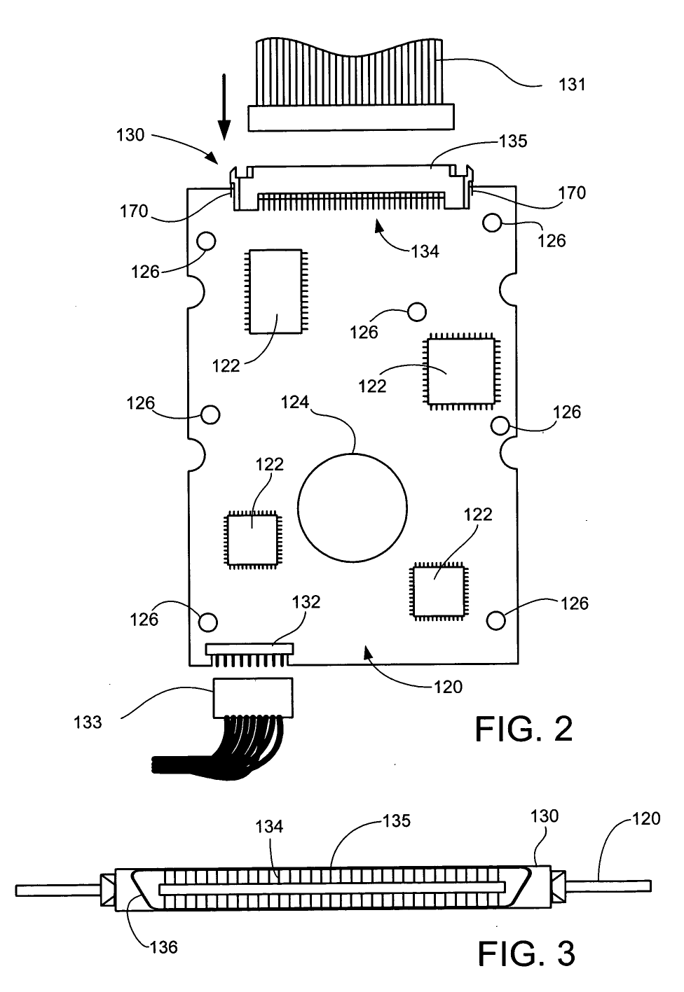

FIG. 2 provides a plan view of a disc drive printed circuit board (PCB) 120. The PCB 120 is mounted to the underside of the base deck 102 and hence, is not visible in FIG. 1. The PCB supports various communication and control electronics (as represented by integrated circuits 122) utilized by the drive 100 during operation.

A central annular aperture 124 allows a portion of the spindle motor 106 to project through the PCB 120. Apertures 126 accommodate fasteners (not shown) used to mount the PCB 120 to the base deck 102.

The PCB 120 further includes a pair of electrical connectors 130, 132 to facilitate electrical interconnection between the drive 100 and the host computer. The connector 130 is a primary interface connector that mates with a ribbon cable 131 to allow the transfer of data between the host computer and the discs 108. The connector 132 is a power connector that mates with a power cable 133 that in turn is connected to a regulated power supply of the host computer.

Of particular interest to the present discussion is the primary interface connector 130. It will be readily understood, though, that the various embodiments presented herein can readily be adapted to the power connector 132, as well as to other types of connectors, and connectors attached to other types of devices. FIG. 3 provides an elevational representation of the connector 130 in conjunction with the PCB 120. As shown in FIGS. 2 and 3, the connector 130 includes a number of individual, adjacent conductive electrical contacts 134 which are supported by and project through a rigid, dielectric body 135 of the connector 130.

A proximal end of each contact 134 is soldered to a corresponding solder pad on the PCB (as generally represented in FIG. 2) in a conventional manner. A distal end of each contact projects into a substantially trapezoidally shaped, keyed mating recess 136 of the connector 130 (see FIG. 3) for mating engagement with the ribbon cable connector, also in a conventional manner. The connector 130 is contemplated as comprising an edge connector, which is a type of connector that engages an edge of the PCB 120 so that a first set of the contacts 134 contact one side of the PCB 120 and a second set of the contacts 134 contact the opposite side of the PCB 120.

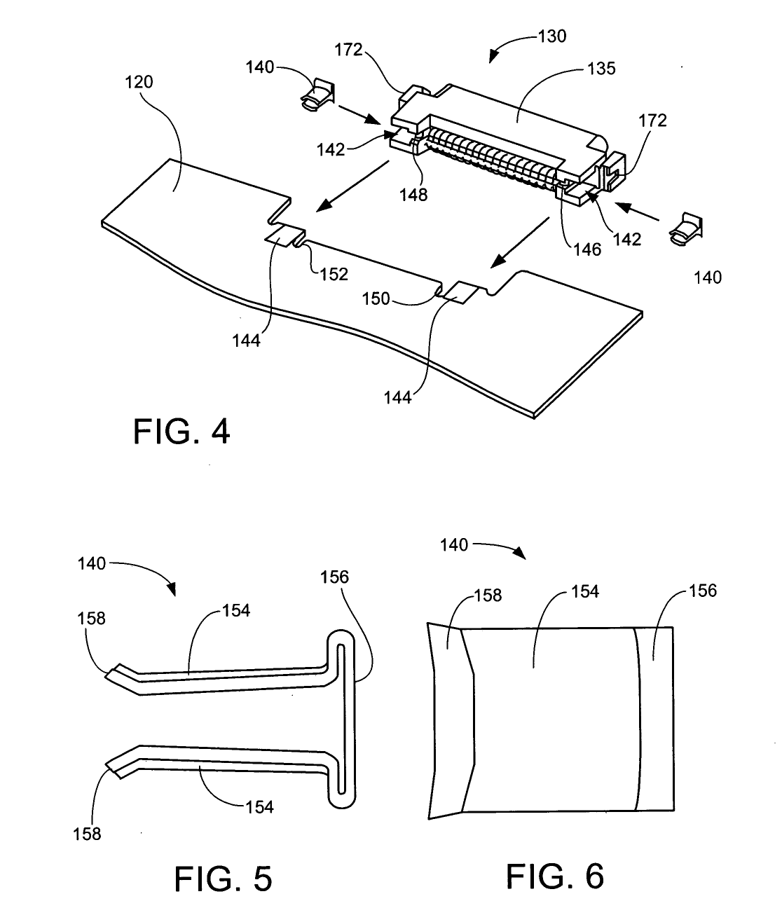

FIG. 4 shows the connector 130 to include a pair of strain relief clips 140 which are configured in accordance with preferred embodiments to further secure the connector 130 to the PCB 120. The strain relief clips 140, also referred to herein as solder clips, are inserted into recesses 142 in the body 135 of the connector 130, as shown. Generally, the solder clips 140 are formed of a suitable metal spring material, and clip onto correspondingly sized solder pads 144 on the top and bottom sides of the PCB 120 as the connector 130 is inserted onto the PCB 120. During a solder reflow operation, both the clips 140 and the contacts 134 are soldered onto the corresponding pads on the PCB.

Keying features are provided to ensure the connector 130 is correctly oriented with respect to the PCB 120 during installation. These keying features comprise a relatively wide interior post 146 and a relatively narrow interior post 148 adjacent the respective recesses 142 in the connector 130. These posts 146, 148 fit into respectively sized recesses 150, 152 adjacent the solder pads 144 in the PCB 120.

The use of the clips 140 in this manner results in the establishment of four structural solder joints that affix the body 135 of the connector 130 to the PCB 120, in addition to the solder joints between the PCB 120 and the electrical contacts 134. Preferably, the clips 140 are configured to fit within the existing outer dimensions of an otherwise standard connector form factor.

It will be noted at this point that the individual widths of the clips 140 (as measured in a direction normal to the direction of insertion of the connector 130) is substantially greater than the individual widths of the contacts 134. This provides larger cross-sectional areas for the solder joints associated with the clips 140 as compared to those of the contacts 134, reducing the stress in the respective joints for a given load and allowing the connector to bear significantly higher strain forces.

The larger cross-sectional areas associated with the clips 140 further create stiffer joints; that is, as load is applied to the connector 130, the contacts 134 will tend to deflect, resulting in the transferring of most of the load to the clips 140.

FIGS. 5 and 6 provide elevational and plan views, respectively, of a preferred construction for the clips 140. Each clip 140 is substantially u-shaped, and includes a pair of elongated cantilevered arms 154. Each of the arms 154 is preferably curved (i.e., concave across the width of each arm) so as to increase the strength of each arm 154 and to increase the amount of solder disposed between the arms 154 and the pads 144. The arms 154 project from a retaining base 156 preferably formed by folding the clip material as shown.

The arms 154 preferably converge toward each other slightly as shown in FIG. 5. This allows an interference fit with the PCB 120 and ensures that the arms 154 are spring biased against the pads 144. Flanges 158 project from the ends of the respective arms 154 to further strengthen the arms 154 and enhance the resulting solder connection.

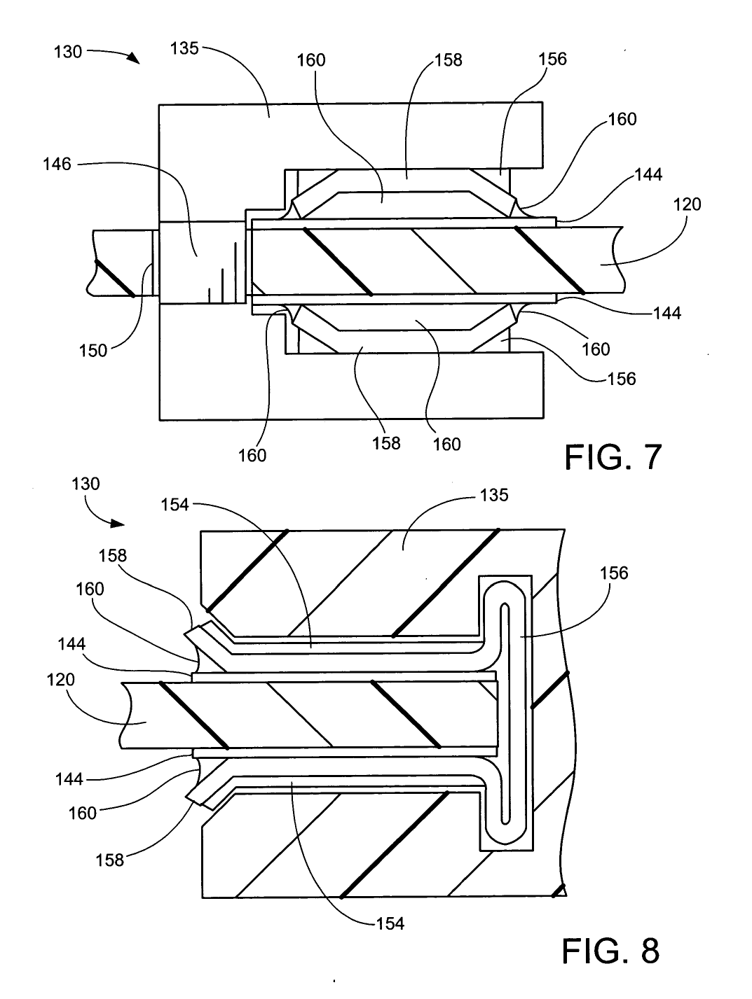

FIGS. 7 and 8 provide partial cross-sectional, elevational views of relevant portions of the PCB 120 and connector 130 to illustrate the manner in which the clips 140 engage the PCB. Solder joints 160 affix the arms 154 to the pads 144 as shown. The keying feature 146 is further shown in FIG. 7 to preferably comprise a recessed post.

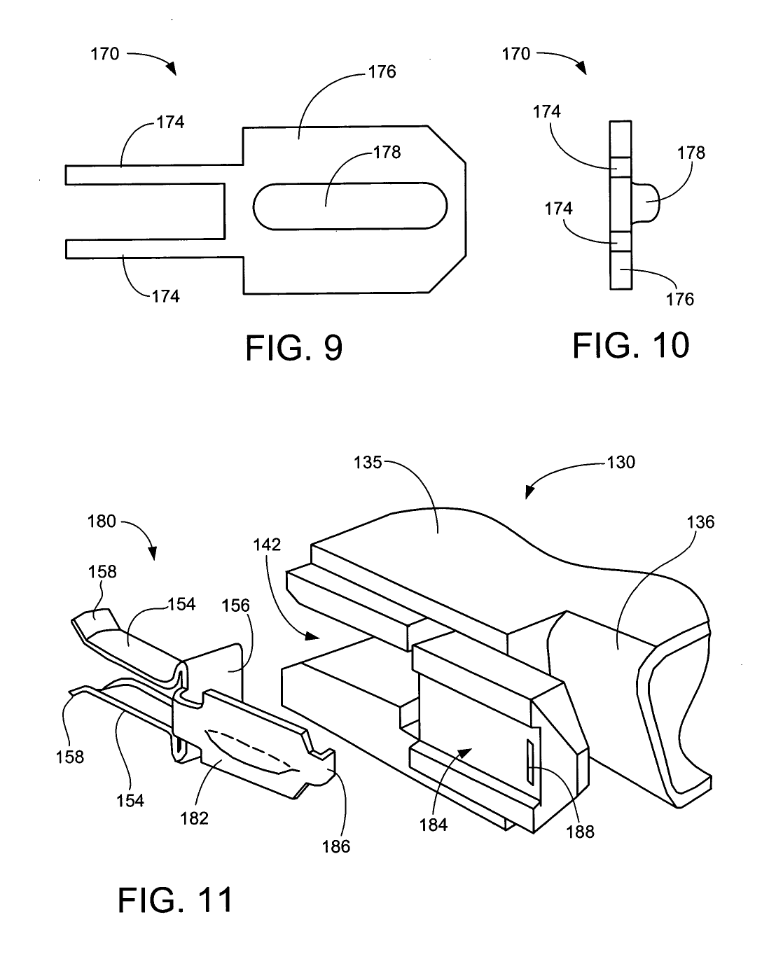

In a preferred embodiment, the solder clips 140 are used in conjunction with advance ground contacts (AGCs) of the connector 130, one of which is illustrated in FIGS. 9 and 10. The connector 130 includes two such AGCs 170, one on each end of the connector 130. For reference, the AGCs 170 are schematically represented in FIG. 2; associated recesses 172 in the body 135 of the connector 130 which receive and support the AGCs 170 are best viewed in FIG. 4.

The AGCs 170 form an electrical conduction path to an internal ground plane or member embedded within the body 135 of the connector 130. To this end, the AGCs 170 include a pair of cantilevered arms 174 which project from a base 176. The base 176 includes a strengthening dimple 178. The arms 174 and are configured to contact and be soldered to corresponding pads (not shown) on the PCB 120. The pads on the PCB 120 are preferably electrically connected to a ground plane within the PCB.

Generally, the arms 174 are dimensioned so that as the connector 130 is inserted onto the PCB 120, the arms 174 establish contact with the associated solder pads on the PCB 120 before the contacts 134 of the connector 130 come into contact with the PCB.

In this way, any difference is electrical potential due to accumulated electrical charge built up in the connector 130 and/or the PCB 120 is quickly and safely dissipated, reducing the likelihood of electrostatic discharges that could cause damage to the connector or neighboring circuitry. Upon installation of the connector 130, the AGCs 170 further serve to nominally maintain the connector 130 at the same potential as the PCB 120 (i.e., the AGCs 170 ground the connector to the PCB 120).

Alternatively, the AGCs 170 can be omitted from the connector 130 and the advanced grounding functions can be incorporated directly into the solder clips, as shown at 180 in FIG. 11.

The solder clip 180 generally includes the same features as described above, with the addition of a grounding extension 182 which projects from the base 156. The grounding extension 182 is received into an AGC recess 184, and a tang 186 is inserted into a slot 188 bounded by the internal grounding plane to complete the grounding connection.

While the solder clip 180 is configured for incorporation into existing connector bodies, it will be understood in an alternative arrangement the clip 140 shown in FIGS. 4-8 can also be configured to carry out the AGC functions, provided the internal ground plane or member within the connector 130 is reconfigured so as to contact the clip 140 once the clip 140 is inserted into the associated recess 142.

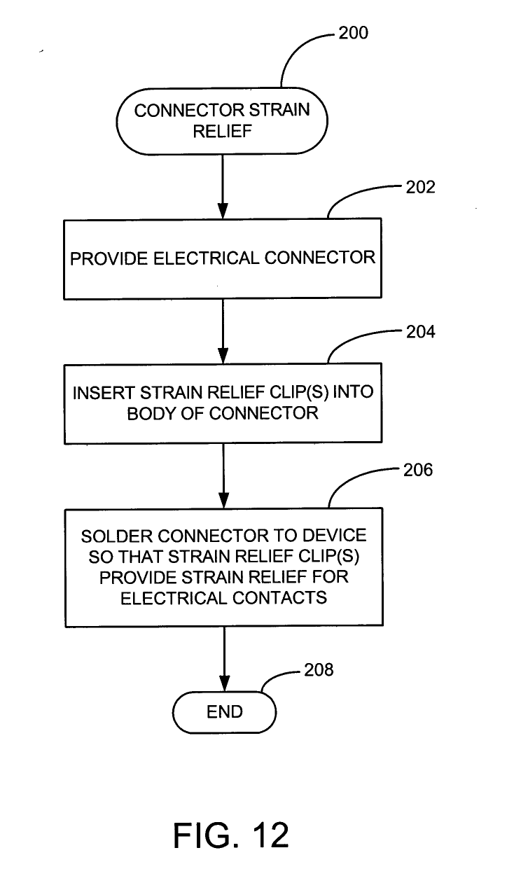

FIG. 12 provides a flow chart for a CONNECTOR STRAIN RELIEF routine 200 to generally summarize steps carried out in accordance with the foregoing discussion.

At step 202, an electrical connector is first provided (such as 130). At step 204, one or more strain relief clips (such as 140, 180) are inserted into the connector preferably as discussed above. As desired, the strain relief clips inserted during step 204 are configured to establish an advanced ground control (AGC) connection at the completion of this step. It is contemplated that steps 202 and 204 are carried out by a connector manufacturer during the manufacture of a population of nominally identical connectors in this fashion.

The completed connector is next provided to an assembly operation wherein the connector is installed onto a device (such as the PCB 130) at step 206. The installation preferably comprises a reflow solder operation so that both the contacts and the clip(s) are soldered to the device. At this point the connector is secured in the final configuration to the device, and the process ends at step 208.

It will now be appreciated that the various preferred embodiments presented herein provide certain advantages over the prior art. The use of the structural solder joints 160 between the clips 140, 180 and the PCB 120 to secure the connector 130 to the PCB 120 eliminates the need for secondary operations to install fasteners, rigid posts, etc. to further secure the connector 130 to the PCB 120.

The clips 140, 180 preferably are configured to fit within industry standard connector form factors, eliminating the need for expensive retooling and ensuring forward and backward compatibility between connectors with and without the clips 140, 180. The advanced ground contact functions of the AGCs can further be incorporated into the clips 140, 180, reducing parts counts and complexity associated with the connectors 130.

In summary, it will now be understood that the present invention (as embodied herein and as claimed below) is generally directed to an apparatus and method for providing strain relief for an electrical connector.

In accordance with preferred embodiments, an electrical connector (such as 130) includes a body (such as 135) which supports a number of electrical contacts (such as 134) each having a proximal end configured for electrical and mechanical engagement to a device (such as PCB 130). A strain relief clip (such as 140, 180) is retained within an associated recess (such as 142) in the body, the strain relief clip configured for attachment to the device using a solder connection to relieve strain forces upon the electrical contacts.

For purposes of the appended claims, the term “electrical contact” (as exemplified by element 134 discussed above) will be read broadly to include both a single piece construction as well as a multi-piece construction; that is, an electrical contact formed from multiple components that meet within the body of the connector will still be viewed as a single contact for purposes of the claims.

The term “solder connection” (as exemplified by element 160 above) will be read broadly to cover any number of existing or future developed methodologies whereby conductive components are joined together in a cementing or fusing type operation, such as but not limited to the use of a fusible alloy that is melted and subsequently cooled to form a bond between the components, as contrasted to other attachment methodologies such as by the use of threaded fasteners, spring biased latch members, press-fit posts, etc.

The recited function of the term “first means” will be expressly understood consistent with the foregoing discussion to correspond to the disclosed strain relief clips 140, 180. The AGCs 170 do not serve to relieve strain upon the connectors and hence are not encompassed within the scope of this term, and are expressly excluded from the definition of an equivalent.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

In addition, although the embodiments described herein are directed to providing strain relief in a primary interface connector in a disc drive PCB, it will be appreciated by those skilled in the art that such embodiments are for purposes of illustration and are not limiting, as other types of connectors and applications can readily be used without departing from the scope of the claimed invention.

What is claimed is:

1. In an electrical connector of the type having a body which supports a number of electrical contacts each having a proximal end configured for electrical and mechanical engagement to a device, the improvement characterized as the electrical connector further comprising a strain relief clip retained by the body of the electrical connector and configured for attachment to the device using a solder connection to relieve strain forces upon the electrical contacts after installation of the electrical connector onto the device.

2. The improvement of claim 1, wherein the strain relief clip comprises a base retained by the body of the electrical connector and a cantilevered arm which projects from the body, the arm configured to pressingly engage a solder pad on the device to accommodate the solder connection therebetween.

3. The improvement of claim 2, wherein the number of electrical contacts and the arm are oriented to substantially project in a first direction toward the device, and wherein a width of the arm along a second direction normal to the first direction is substantially greater than a width of each of the number of electrical contacts along said second direction.

4. The improvement of claim 1, wherein the proximal end of each of the electrical contacts is configured for attachment to the device using a solder connection.

5. The improvement of claim 1, wherein the device comprises a printed circuit board (PCB).

6. The improvement of claim 5, wherein the electrical connector comprises an edge connector so that a first portion of the electrical contacts engage a first side of the PCB and a second portion of the electrical contacts engage a second, opposing side of the PCB.

7. The improvement of claim 6, wherein the strain relief clip has a substantially u-shaped construction comprising a base retained by the body of the electrical connector and a pair of opposing cantilevered arms which project from the body, the arms configured to pressingly engage respective solder pads on the opposing first and second sides of the PCB to accommodate respective solder connections between the solder pads and the arms.

8. The improvement of claim 1, wherein the electrical connector further includes an internal conductive grounding plane member and wherein the strain relief clip is electrically connected to said member so that, upon installation of the electrical connector onto the device, the strain relief clip establishes contact with the device prior to contact between the number of electrical contacts and the device, thereby establishing a discharge path for electrical charge between the device and the connector prior to contact between the electrical contacts and the device.

9. The improvement of claim 1, wherein the device comprises a printed circuit board (PCB) of a disc drive data storage device, and wherein the electrical connector comprises a primary interface connector configured to establish a data transfer path with a host computer with which the disc drive data storage device is associated.

10. An electrical connector, comprising:
a body;
a number of electrical contacts each having a proximal end configured for electrical and mechanical engagement to a device; and
first means for relieving strain forces upon the electrical contacts after installation of the electrical connector onto the device.

11. The electrical connector of claim 10, wherein the first means further includes means for establishing an advanced ground control path for the electrical connector.

12. A method for providing strain relief for an electrical connector, comprising:
providing an electrical connector with a body which supports a number of electrical contacts each having a proximal end configured for electrical and mechanical engagement to a device; and
inserting a strain relief clip into an associated recess in the body, the strain relief clip configured for attachment to the device using a solder connection to relieve strain forces upon the electrical contacts.

13. The method of claim 12, further comprising a subsequent step of installing the electrical connector onto the device.

14. The method of claim 13, wherein the installing step comprises subjecting the device and the electrical connector to a soldering operation so that the proximal end of each of the electrical contacts and the strain relief clip are respectively attached to the device using respective solder connections.

15. The method of claim 14, wherein the device to which the electrical connector is attached during the installing step comprises a printed circuit board (PCB).

16. The method of claim 15, wherein the PCB of the installing step comprises a disc drive data storage device PCB, and wherein the electrical connector of the providing step comprises a primary interface connector configured to establish a data transfer path with a host computer with which the disc drive data storage device is associated.

17. The method of claim 12, wherein the strain relief clip of the inserting step comprises a base retained by the body of the electrical connector and a cantilevered arm which projects from the body, the arm configured to pressingly engage a solder pad on the device to accommodate the solder connection therebetween.

18. The method of claim 17, wherein the number of electrical contacts of the providing step and the arm of the inserting step are oriented to substantially project in a first direction toward the device, and wherein a width of the arm along a second direction normal to the first direction is substantially greater than a width of each of the number of electrical contacts along said second direction.

19. The improvement of claim 5, wherein the electrical connector comprises an edge connector so that a first portion of the electrical contacts engage a first side of the PCB and a second portion of the electrical contacts engage a second, opposing side of the PCB.

20. The improvement of claim 6, wherein the strain relief clip has a substantially u-shaped construction comprising a base retained by the body of the electrical connector and a pair of opposing cantilevered arms which project from the body, the arms configured to pressingly engage respective solder pads on the opposing first and second sides of the PCB to accommodate respective solder connections between the solder pads and the arms.
